(19) United States
(12) Patent Application Publication
(10) Pub. No.: US 2010/0192791 A1
(43) Pub. Date: Aug. 5, 2010

(54) METHOD FOR OBTAINING A COATING (METAL-BACK PRINTING BLANKET) OF A TYPOGRAPHIC PRINTING ROLL WITH NON-ADHESIVE PLASTIC SHEET, AND METAL-BACK PRINTING BLANKET THUS OBTAINED

(75) Inventors: Gianpietro Invernizzi, Lodi (IT); Fausto Zeni, Secugnago (IT)

Correspondence Address: Clements Bernard PLLC, 1901 Roxborough Road, Suite 250, Charlotte, NC, 28211, US

(73) Assignee: TRELLEBORG ENGINEERED SYSTEMS ITALY S.P.A., Milan (IT)

(21) Appl. No.: 12/667,567

(22) PCT Filed: Jul. 4, 2008
(86) PCT No.: PCT/IB2008/052697

§ 371 Date: Jan. 4, 2010

(30) Foreign Application Priority Data
Jul. 6, 2007 (IT) MI2007A001350

(51) Int. Cl. B41N 1/04; C09J 201/00; C09J 4/00

(52) U.S. Cl. 101/395; 156/331.7; 156/330; 156/330.9

(57) ABSTRACT

Described herein is a method for providing the coating (metal-back printing blanket) of a typographic printing roll, said coating comprising a metal layer, one or more upper layers, and a sheet of plastic material on the bottom surface of the metal layer, the method comprising the step of sealing one or more edges of the plastic sheet to the metal layer by means of an adhesive tape applied between the edge of the plastic sheet and the metal layer.

The present invention relates to a method for providing a coating (metal-back printing blanket) of a typographic printing roll with a non-adhesive plastic sheet, and metal-back printing blanket thus obtained.

Offset typographic printing machines are made up of a number of rolls, some of which simply carry out a driving function in regard to the paper that is passing through, whilst others are involved, in particular, in the printing process. Amongst the latter rolls, at least one performs the function of taking the ink from the printing plate or matrix and transferring it to the paper. The roll or cylinder that is to receive the ink from the plate and transfer it to the paper is made of steel coated with a rubberized fabric referred to in the technical sector as “offset printing blanket” which must guarantee that the ink is taken up efficiently from the printing matrix with a consequent good transfer of the ink itself to the paper to be printed.

An offset printing blanket is typically made up of different layers, generally of rubber and fabric; its outer part (top part) is made of rubber, and the bottom part in contact with the printing roll is generally made of fabric.

In the case, instead, of a coating referred to in the technical sector and in what follows as <<metal-back printing blanket>>, the bottom part in contact with the printing roll is constituted by a metal layer made of stainless steel.

The metal-back printing blanket is wound around the steel roll, which envisages a transverse slit, referred to as “gap”, within which the terminal edges of the metal base of the metal-back printing blanket are inserted and fixed.

The printing roll and the metal-back printing blanket wound around it are subject to phenomena of corrosion and wear due in part to mutual rubbing and in part to the corrosive action of the chemical substances used both in the printing process and in the steps of cleaning after use.

In order to overcome the effects of corrosion and wear it is known from the U.S. Pat. No. 6,912,955 to coat the bottom surface of the metal-back printing blanket, which must come into contact with the printing roll, with a plasma treatment.

It is likewise known to insert between the metal layer of the metal-back printing blanket and the surface of the printing roll a sheet of plastic material, which can be wound around the printing roll, or else fixed on the bottom surface of the metal layer of the blanket. Fixing is obtained with an adhesive of the acrylic PSA (Pressure Sensitive Adhesive) type.

The above adhesive, however, presents problems due to the fact that it does not resist effectively the solvents used in the processes of printing and above all of washing of the surface, in addition to not presenting a sufficient adhesion at temperatures higher than 60° C.

The solvent tends to penetrate from the edges of the plastic sheet and corrode the adhesive, forming also bubbles and peeling of the coating. The most problematical consequence is that the plastic sheet tends to slide and displace with respect to the metal layer of the metal-back printing blanket, with consequent machine downtime for replacement of the metal-back printing blanket itself and consequent reduction in productivity.

Likewise known to the art is to use, in the field of coatings of the classic offset-printing-blanket type, a plastic sheet without adhesive between the surface of the printing roll and the offset printing blanket. The sheet is applied underneath the entire surface of the offset printing blanket, including the terminal edges, and is inserted in the gap together with said edges, where is then engaged and fixed with purposely provided stays.

In the case of the metal-back printing blanket, however, there is no possibility of anchoring the plastic sheet inside the gap of the printing roll in so far as the fixing system is different.

Consequently, the purpose of the present invention is to overcome the aforesaid drawbacks and indicate a method for providing the coating of the metal-back-printing-blanket type for a typographic printing roll with a non-adhesive plastic sheet, and a metal-back printing blanket thus obtained, which prevents penetration of the solvents and guarantees perfect adhesion of the plastic sheet to the metal-back printing blanket.

The subject of the present invention is a method for providing a coating for a typographic printing roll, said coating, referred to as “metal-back printing blanket”, comprising at least one metal layer, one or more upper layers, and a non-adhesive sheet of plastic material on the bottom surface of the metal layer, said method being characterized in that it comprises the step of gluing one or more edges of the non-adhesive sheet of plastic material to the metal layer by means of an adhesive material applied between the edge of the plastic sheet and the metal layer.

A particular subject of the present invention is a method for providing a coating (metal-back printing blanket) for a typographic printing roll with a non-adhesive plastic sheet, and a metal-back printing blanket thus obtained, as will be described more fully in the claims, which form an integral part of the present description.

Further purposes and advantages of the present invention will emerge clearly from the ensuing detailed description of an example of embodiment thereof (and of its variants) and from the annexed plate of drawings, which is provided purely by way of explanatory and non-limiting example and in which:

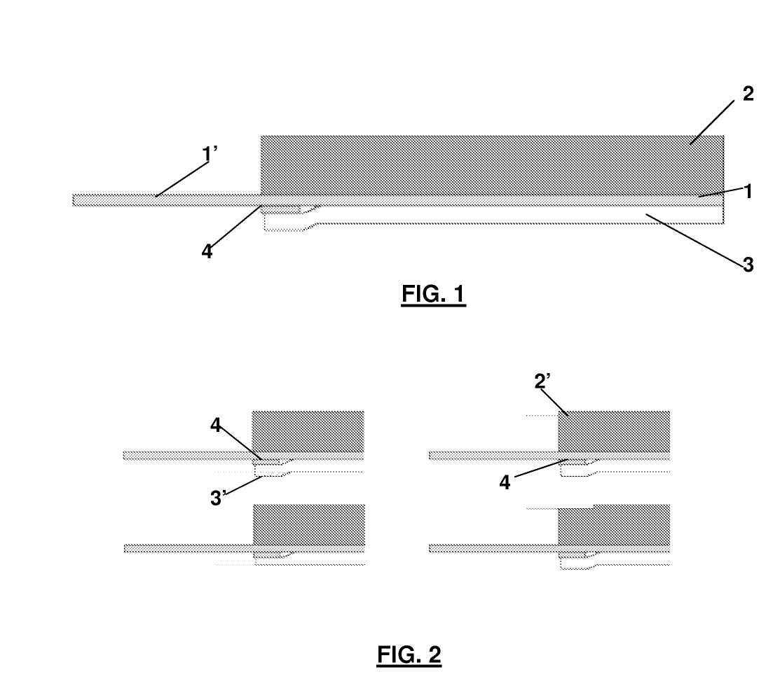

FIG. 1 shows a cross-sectional side view of the metal-back printing blanket provided with plastic sheet, forming the subject of the present invention;

FIG. 2 shows a detail of FIG. 1 regarding a step of milling.

With reference to FIG. 1, the reference number 1 designates the metal layer of the metal-back printing blanket, whilst the reference number 2 designates the set of the upper layers of the metal-back printing blanket (one or more layers) obtained using a well-known technique.

The reference number 3 designates a sheet of plastic material, for example, polyester, set on the bottom surface of the metal layer 1 of the blanket. Preferably, the plastic sheet 3 occupies a major part of the bottom surface of the metal layer, with the exclusion of the edge 1′, which is folded back and inserted in the gap of the printing roll not represented in the figure.

Then according to the main aspect of the present invention, one or more edges of the plastic sheet 3 are glued to the metal layer 1 by means of an adhesive material, which, in this example of embodiment, is an adhesive tape 4 applied between the edge of the plastic sheet 3 and the adjacent metal layer 1.

Preferably, the adhesive tape is of the thermo-adhesive type, provided with thermoplastic or thermosetting glue, which is able to undergo vulcanizing and cross-linking, and proves resistant to the solvents typically used and to the high temperatures, higher than 60° C., which can develop during normal use of the metal-back printing blanket.

The adhesive tape can be of a single-layer or multilayer type, even with intermediate supporting layers, which can be made, for example, of plastic material (polyester, polyvinyl chloride, polypropylene, polyurethane, etc.), of paper, or else of non-woven fabric.

The glue of the adhesive tape can comprise, for example, one or more of the following materials: thermoplastic polyurethane, polyvinyl chloride, copolymers with vinyl acetate, thermosetting polyurethane, polyester, polyamide, polyolephin, phenolic resins, epoxy adhesives, polyurethane adhesives, polyacrylic adhesives, etc.

According to another example of embodiment, the adhesive material 4 can also present as fluid or gel layer with a material composition comprising one or more materials, for example, chosen from amongst the ones referred to above, which is spread or applied with a purposely provided tool, for example, a paintbrush, a spatula, a roller, a gun or by spraying.

Preferably, the adhesive tape 4 is applied only to the edge of the plastic sheet set at the so-called “leading edge” of the metal-back printing blanket, i.e., the edge that is in front with respect to the direction of rotation of the printing roll, at one side of the gap of the printing roll, since in this point there is the highest stress due to sliding of the plastic sheet 3 with respect to the metal layer 1 and/or to the printing roll, and it is hence in this point that adhesion by gluing is obtained.

Obviously, the tape can appropriately be applied on a number or all of the sides of the plastic sheet, on the side edges and on the so-called “trailing edge”, the edge that is at the back with respect to the direction of rotation of the printing roll, at the other side of the gap of the printing roll.

With reference to FIG. 2, in order to prevent the thickness of the adhesive tape 4 from creating an undesirable overall thickening of the metal-back printing blanket in the points in which it is applied, a thickening that could adversely affect proper rotation of the printing roll and a correct printing process, there is preferably carried out a milling of the outer edge 3′ of the plastic sheet 3 on which the tape 4 is applied so as to render the overall thickness of the stretch that comprises the edge of the plastic sheet and the adhesive tape uniform. Alternatively, the milling can be made on the top edge 2′ of the metal-back printing blanket.

Variants are possible to the non-limiting example described, without this implying any departure from the sphere of protection of the present invention, said variants comprising all the embodiments that are equivalent for a person skilled in the branch.

The advantages deriving from the application of the present invention are clear.

The application of the adhesive tape 4 guarantees fixing of the plastic sheet to the metal-back printing blanket, given that it is possible to avoid using the self-adhesive plastic sheet with adhesive of a PSA (Pressure Sensitive Adhesive) type.

From the above description the person skilled in the branch is able to reproduce the object of the invention without introducing any further constructional details.

1. A method for providing a coating for a typographic printing roll, said coating, referred to in the following as “metal-back printing blanket”, comprising at least one metal layer, one or more upper layers, and a non-adhesive sheet of plastic material on the bottom surface of the metal layer, said method comprising a step of gluing one or more edges of the non-adhesive sheet of plastic material to the metal layer by means of an adhesive material applied between the edge of the plastic sheet and the metal layer.

2. The method according to claim 1, wherein said adhesive material is an adhesive tape of the thermo-adhesive type, provided with thermoplastic or thermosetting glue.

3. The method according to claim 2, wherein said adhesive tape is single-layer or multilayer.

4. The method according to claim 3, wherein said single-layer or multilayer adhesive tape comprises intermediate supporting layers of plastic material, such as polyester, polyvinyl chloride, polypropylene, polyurethane, or else paper, or else non-woven fabric.

5. The method according to claim 2, wherein said thermoplastic or thermosetting glue comprises one or more of the following materials: thermoplastic polyurethane, polyvinyl chloride, copolymers with vinyl acetate, thermosetting polyurethane, polyester, polyamide, polyolephin, phenolic resins, epoxy adhesives, polyurethane adhesives, polyacrylic adhesives.

6. The method according to claim 1, wherein said adhesive material is a fluid or gel layer.

7. The method according to claim 1, wherein said plastic sheet is applied on a major part of the bottom surface of the metal layer, with the exclusion of the edge, which is folded back and inserted in a gap provided in the typographic printing roll.

8. The method according to claim 1, wherein said adhesive tape is applied at least to the edge of the plastic sheet set at the leading edge of the coating.

9. The method according to claim 1, further comprising a step of milling of said one or more external edges of said plastic sheet on which said adhesive tape is applied so as to render the overall thickness of the stretch that comprises the edge of the plastic sheet and the adhesive tape uniform.

10. The method according to claim 1, further comprising a step of milling of the top edge of said upper layer in an area corresponding to the points on which said adhesive tape is applied so as to render the overall thickness of the stretch that comprises the edge of the plastic sheet and the adhesive tape uniform.

11. A metal-back printing blanket for a typographic printing roll, comprising at least one metal layer, one or more upper layers, and a non-adhesive sheet of plastic material on the bottom surface of the metal layer, said metal-back printing blanket comprising an adhesive material applied on one or more edges of the non-adhesive sheet of plastic material, between the edge of the plastic sheet and the metal layer.

12. The metal-back printing blanket according to claim 11, wherein said adhesive material is an adhesive tape of the thermo-adhesive type, provided with thermoplastic or thermosetting glue.

13. The metal-back printing blanket according to claim 12, wherein said adhesive tape is single-layer or multilayer.

14. The metal-back printing blanket according to claim 13, wherein said single-layer or multilayer adhesive tape comprises intermediate supporting layers of plastic material, such as polyester, polyvinyl chloride, polypropylene, polyurethane, or else paper, or else non-woven fabric.

15. The metal-back printing blanket according to claim 12, wherein said thermoplastic or thermosetting glue comprises one or more of the following materials: thermoplastic polyurethane, polyvinyl chloride, copolymers with vinyl acetate, thermosetting polyurethane, polyester, polyamide, polyolephin, phenolic resins, epoxy adhesives, polyurethane adhesives, polyacrylic adhesives.

16. The metal-back printing blanket according to claim 11, wherein said adhesive material is a fluid or gel layer.

17. The metal-back printing blanket according to claim 11, wherein said plastic sheet is applied on a major part of the bottom surface of the metal layer, with the exclusion of the edge, which is folded back and inserted in a gap provided in the typographic printing roll.

18. The metal-back printing blanket according to claim 11, wherein said adhesive tape is applied at least to the edge of the plastic sheet set at the leading edge of the coating.

19. The metal-back printing blanket according to claim 11, wherein said one or more edges of said plastic sheet are milled in an area corresponding to the points on which said adhesive tape is applied so as to render the overall thickness of the stretch that comprises the edge of the plastic sheet and the adhesive tape uniform.

20. The metal-back printing blanket according to claim 11, wherein the top edge of said upper layer is milled in an area corresponding to the points on which said adhesive tape is applied so as to render the overall thickness of the stretch that comprises the edge of the plastic sheet and the adhesive tape uniform.
